(19) United States
(12) Patent Application Publication
(10) Pub. No.: US 2016/0071506 A1
(43) Pub. Date: Mar. 10, 2016

(54) Acoustic Interface Assembly With Porous Material

(71) Applicant: Knowles Electronics, LLC, Itasca, IL (US)

(72) Inventors: Sarmad Qutub, Des Plaines, IL (US); Oddy Khamharn, Lombard, IL (US); Martin Volk, Willowbrook, IL (US); William Ryan, Elgin, IL (US)

(21) Appl. No.: 14/844,513

(22) Filed: Sep. 3, 2015

Related U.S. Application Data
(60) Provisional application No. 62/047,759, filed on Sep. 9, 2014.

(51) Int. Cl. G10K 11/162; H04R 1/08

(52) U.S. Cl. CPC G10K 11/162; H04R 1/08; H04R 2410/03

(57) ABSTRACT

Approaches are provided for an acoustic apparatus including a base, a transducer coupled to the base, an acoustic interface assembly, and a cover disposed on the base and enclosing the acoustic interface assembly and the transducer. The cover includes a port extending through the cover. The acoustic interface assembly includes an inlet that extends from a first surface of the acoustic interface assembly to a second surface of the acoustic interface assembly. The inlet is at least partially filled with a porous material. The transducer is disposed proximal to the acoustic interface assembly such that the inlet of the acoustic interface assembly couples the transducer to the port extending through the cover.

### CROSS-REFERENCE TO RELATED APPLICATION

This patent claims benefit under 35 U.S.C. §119(e) to U.S. Provisional Application No. 62/047,759 entitled “Acoustic Interface Assembly With Porous Material” filed Sep. 9, 2014, the content of which is incorporated herein by reference in its entirety.

### TECHNICAL FIELD

This application relates to acoustic devices and, more specifically, to microphones and alleviating noise problems associated with these microphones.

### BACKGROUND OF THE INVENTION

Different types of acoustic devices have been used through the years. One type of device is a microphone. In a microelectromechanical system (MEMS) microphone, a MEMS die includes a diagram and a back plate. The MEMS die is supported by a substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential on the back plate or diaphragm, which creates an electrical signal. Microphones are deployed in various types of devices such as personal computers or cellular phones.

One issue with microphone usage is associated with operating in environments when there can be noise. For instance, windy environments can introduce noise problems for microphones. In some situations, the noise may interfere with the sounds that are desired to be heard by a listener, and as a result of the noise the listener cannot hear or ascertain the wanted sounds.

Various attempts have been made to alleviate noise issues associated with microphone operation, but these previous approaches generally have had disadvantages that limited their usefulness. This has resulted in some general user dissatisfaction with present approaches.

### BRIEF DESCRIPTION OF THE DRAWINGS

For a more complete understanding of the disclosure, reference should be made to the following detailed description and accompanying drawings wherein:

FIG. 1 comprises a side cutaway view of a assembly including an acoustic interface assembly with a porous material according to various embodiments of the present invention;

FIG. 2 comprises a side cutaway view of another example of an assembly including an acoustic interface assembly with a porous material according to various embodiments of the present invention;

FIG. 3 comprises a side cutaway view of another example of an assembly including an acoustic interface assembly with a porous material according to various embodiments of the present invention;

FIG. 4A comprises a side cutaway view of an acoustic interface assembly with an alternative opening according to various embodiments of the present invention;

FIG. 4B comprises a side cutaway view of an acoustic interface assembly with an alternative opening according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the present approaches, an acoustic interface assembly includes a base, a transducer coupled to the base, an acoustic interface assembly, and a cover disposed on the base and enclosing the acoustic interface assembly and the transducer. The cover includes a port extending through the cover. The acoustic interface assembly includes an inlet that extends from a first surface of the acoustic interface assembly to a second surface of the acoustic interface assembly. The transducer is disposed proximal to the acoustic interface assembly such that the inlet of the acoustic interface assembly couples the transducer to the port extending through the cover.

The inlet is least partially filled with a porous material. The porous material acts as an acoustic resistor to sound energy that traverses through the opening. The porous material also acts as a contaminant filter that prevents contaminants (e.g., particles, solids, liquids, gases) from traversing through the opening.

In some aspects, the inlet has a constant diameter along a length of the inlet. For example, the inlet can be a tube-like or tunnel-like opening having a predetermined diameter and extending from one side of the acoustic interface assembly to another side of the acoustic interface assembly. In another example, the inlet can vary in size along its length, for instance, having wider areas in some portions of its length than at other portions of its length.

In some other aspects, the porous material may fill all or some portions of the inlet. In one approach, the inlet includes a first porous material region, a second porous material region, and a cavity substantially devoid of porous material positioned between the first and second porous material regions. The porous material may be separate from the acoustic interface assembly (and disposed in the opening by an appropriate manufacturing technique such as injection) or integrally formed with the acoustic interface assembly.

The inlet may pass straight though the acoustic interface assembly, that is, its entire path may be generally perpendicular to a surface of the acoustic interface assembly. In other examples, the inlet may be bent at an angle with respect to a surface. In still other examples, the inlet may enter the acoustic interface assembly at a predefined angle with respect to a surface, but then be bent at an angle (e.g., a 90° angle) and then exit the acoustic interface assembly .

The acoustic interface assembly may be constructed on a variety of different materials. In one example, it may be constructed of rubber. Other examples of materials may also be used to construct the acoustic interface assembly.

The acoustic interface assembly may couple to a transducer or a microphone, for example, a microelectromechanical system (MEMS) microphone. The transducer or microphone may be disposed on a surface (e.g., a printed circuit board). The transducer or microphone may be enclosed by coupling housing to the surface. Other electronic devices may be disposed on the surface. The housing may be the outer casing of a cellular phone, a personal computer, or a tablet to mention a few examples.

The acoustic interface assembly may couple to the cover and the inlet in the interface assembly may communicate with an opening that extends through the cover. Consequently, sound energy external to the housing may pass though the opening in the cover/housing, traverse through the opening, and then enter the transducer or microphone. The transducer or microphone converts the sound energy to electrical signals, which can be further processed by the other electrical devices disposed on the surface.

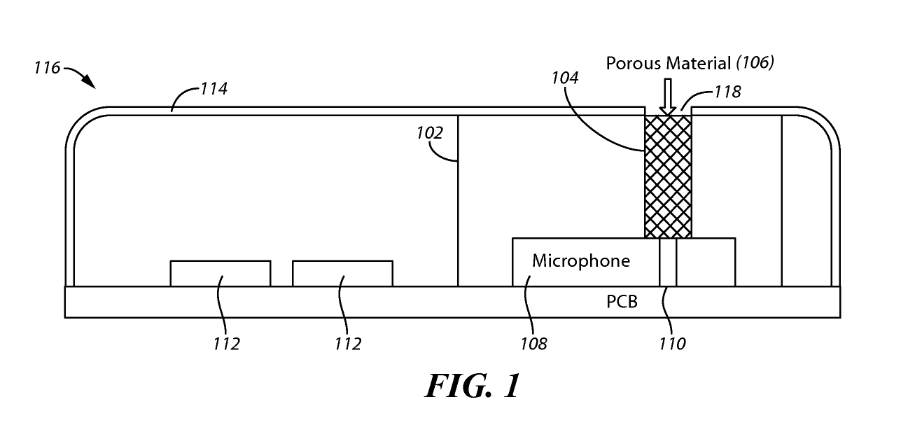

Referring now to FIG. 1, one example of an acoustic interface assembly and its usage within the various types of electronic devices is described. An acoustic interface assembly 102 includes an inlet 104, which extends and is formed through the acoustic interface assembly 102. In one example, the acoustic interface assembly 102 is formed of solid rubber and the inlet 104 is a hollow tube-like or tunnel-like opening. However, it will be appreciated that other materials for the acoustic interface assembly 102 and other configurations for the inlet 104 are possible. In other aspects, the acoustic interface assembly 102 is a gasket or gasket-like structure that provides an acoustic seal between two objects.

Porous material 106 is disposed within the inlet 104. In one example, the porous material 106 is a sponge-like material such as open cell foam. Other examples of porous material may also be used. The porous material 106 acts as an acoustic filter (or resistor) that is effective to filter (or dissipate) sound energy of particular frequencies (e.g., noise) from passing through the inlet 104. The porous material 106 also acts as a contaminant filter to prevent solids, liquids, or gases from traversing through the inlet 104. The porous material 106 may be deposited separately into the inlet 104 (e.g., with an injection approach), or may be integrally formed with the acoustic interface assembly 102. In the example of FIG. 1, the

A transducer or microphone 108 is disposed on a surface 110. The acoustic interface assembly 102 couples to the microphone 108. More specifically, the inlet 104 of the acoustic interface assembly 102 communicates with a port in the microphone 108.

The microphone 108 may be any type of microphone. In one example, the microphone 108 is a microelectromechanical system (MEMS) microphone. Other examples of microphones are possible.

The surface 110 may in one example be a printed circuit board (PCB). In other examples, the surface 110 may be a solid surface or case (e.g., a plastic surface). In the example of FIG. 1, the surface 110 is a printed circuit board. Conductive paths on the printed circuit board 110 allow communication between the microphone 108 and electronic devices 112. The electronic devices 112 may be any type of passive or active electronic devices such as microprocessors, controllers, computer chips (of any type), memory units, capacitors, resistors, inductors, application specific integrated circuits (ASICs), and any combination of these elements to mention a few examples.

A case 114 couples to the surface of the acoustic interface assembly 102 and encloses the components therein. Together, the acoustic interface assembly 102 and various internal components may or may not form an assembly 116. The assembly 116 may be a subcomponent (or part of) cellular phone, personal computer, or tablets to mention a few examples. The electronic devices 112 described above may perform specific functions related to the type of assembly in which the electronic devices are deployed. For example, the electronic devices 112 may perform functions related to a cellular phone if the assembly 116 is a cellular phone, or the electronic devices 112 may perform functions related to a personal computer if the assembly 116 is a personal computer. In one aspect, the assembly 116 does not necessarily have to consist of an entire cell phone, laptop, and so forth. Rather, the assembly may simply be a subcomponent or just part of the electronic device.

An opening 118 extends through the case 114 and in one aspect communicates with the inlet 104 of the acoustic interface assembly 102. A seal is formed between the acoustic interface assembly 102 and the case 114. Another seal may be made between the acoustic interface assembly 102 and the microphone 108. In one example, the acoustic interface assembly 102 has a height that is approximately 2.5 times the height of the microphone 108. Other dimensions and relative dimensions are possible and can be used.

In operation, sound energy enters the opening 118 and then passes into the inlet 104 of the acoustic interface assembly 102. The sound energy traverses through the inlet 104 and through the porous material 106 that at least partially fills the inlet 104. The porous material 106 acts as an acoustic resistor that filters out unwanted noise from the sound energy and passing desired signals. The porous material 106 also advantageously acts as a contaminant filter preventing contaminants from traversing through the opening 106 and entering the microphone 108 via the port in the microphone 108.

The microphone 108 receives the desired sound energy via its port, converts the sound energy into electrical signals, and transmits the electrical signals to all or some of the electronic devices 112. The electrical devices 112 may further process the received electrical signals.

Advantageously, embedding porous material into the opening reduces the effect of noise (e.g., wind noise) and improves the signal-to-noise ratio (SNR) of the microphone. Easier integration of the porous material into the acoustic interface assembly allows easier integration into small electronic devices. Wind-noise reduction algorithms that are used to process the microphone's electrical signal within the device 116 will also achieve improved performance.

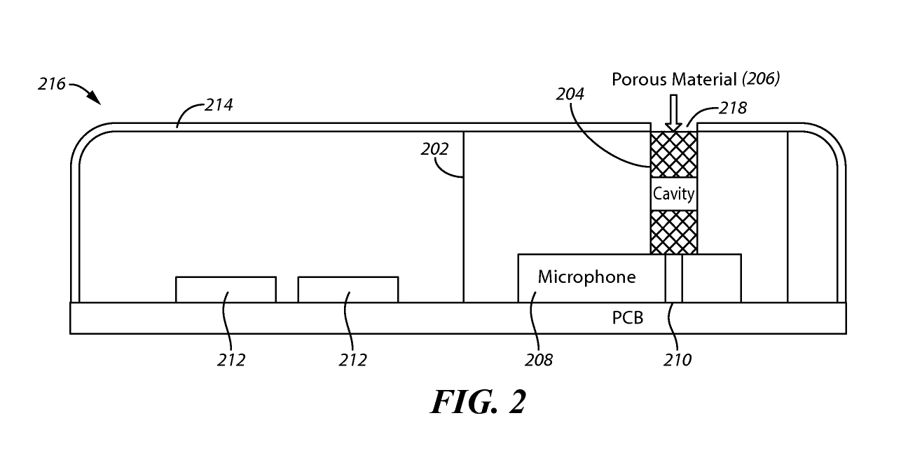

Referring now to FIG. 2, another example of an acoustic interface assembly and its usage within the various electronic devices is described. An acoustic interface assembly 202 includes and inlet 204 that extends and is formed through the acoustic interface assembly. In one example, the acoustic interface assembly 202 is formed of solid rubber and the inlet 204 is a hollow tube-like or tunnel-like opening. However, it will be appreciated that other materials for the acoustic interface assembly 202 and other configurations for the opening are possible. In other aspects, the acoustic interface assembly 202 is a gasket or gasket-like structure that provides an acoustic seal between two objects.

Porous material 206 is disposed within the inlet 204. A transducer or microphone 208 is disposed on a surface 210, which in this example is a printed circuit board. The acoustic interface assembly 202 couples to the microphone 208. More specifically, the inlet 204 of the acoustic interface assembly 202 communicates with a port in the microphone 208. Conductive paths on the printed circuit board 210 allow communication between the microphone 208 and electronic devices 212. A case 214 couples to the surface 210 and encloses the components therein. Together, the case 214 and various internal components form an assembly 216.

An opening 218 extends through the case 214 and in one aspect communicates with the inlet 204 of the acoustic interface assembly 202. A seal is formed between the acoustic interface assembly 202 and the case 214 and another seal is made between the acoustic interface assembly 202 and the microphone 208. These components are similar to like-numbered components described with respect to FIG. 1 and their description and operation will not be repeated here.

A difference between the example apparatus of FIG. 1 and the example apparatus of FIG. 2 is that the opening 204 has a cavity 220 formed in the inlet 204 that is not filled with porous material 206. The cavity 220 is used to equalize acoustic pressure.

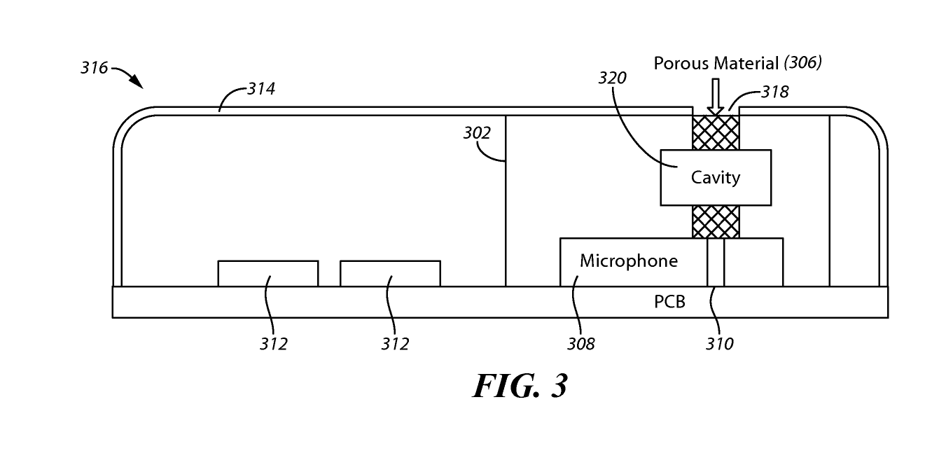

Referring now to FIG. 3, another example of an acoustic interface assembly and its usage within the other electronic devices is described. An acoustic interface assembly 302 includes and inlet 304 that extends and is formed through the acoustic interface assembly. In one example, the acoustic interface assembly 302 is formed of solid rubber and the inlet 304 is a hollow tube-like or tunnel-like opening. However, it will be appreciated that other materials for the acoustic interface assembly 302 and other configurations for the inlet 304 are possible. In other aspects, the acoustic interface assembly 302 is a gasket or gasket-like structure that provides an acoustic seal between two objects.

Porous material 306 is disposed within the opening 304. A transducer or microphone 308 is disposed on a surface 310, which in this example is a printed circuit board. The acoustic interface assembly 302 couples to the microphone 308. More specifically, the inlet 304 of the acoustic interface assembly 302 communicates with a port in the microphone 308. Conductive paths on the printed circuit board 310 allow communication between the microphone 308 and electronic devices 312. A case 314 couples to the surface 310 and encloses the components therein. Together, the case 314 and various internal components form an assembly 316.

An opening 318 extends through the case 314 and in one aspect communicates with the opening 304 of the acoustic interface assembly 302. A seal is formed between the acoustic interface assembly 302 and the case 314 and another seal is formed between the acoustic interface assembly 302 and the microphone 308. These components are similar to like-numbered components described with respect to FIG. 1 and FIG. 2 and their description and operation will not be repeated here.

A difference between the example apparatus of FIG. 3 and the example apparatus of FIG. 2 is that in the example of FIG. 3 the opening 304 has a cavity 320 formed in the inlet 304 that is not filled with porous material 306, and this cavity 320 is of wider diameter (or of greater dimensions) than the rest of the opening 304. The cavity 320 is used to equalize acoustic pressure.

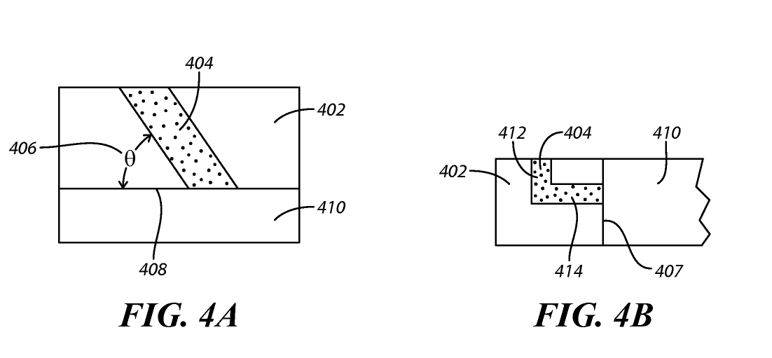

Referring now to FIG. 4A and FIG. 4B, other examples of openings in acoustic interface assemblies are described. In both examples, an acoustic interface assembly 402 includes an inlet 404. The inlet 404 communicates with a port on a transducer or microphone 410. In the example of FIG. 4A, the inlet 404 is arranged at an angle 406 with respect to a surface 408 of a microphone 410. In the example of FIG. 4B, the acoustic interface assembly 402 is disposed on a side 407 of the microphone 410. The inlet 404 includes a 90 degree bend and includes a vertical portion 412 and a horizontal portion 414. It will be appreciated that a porous material is deposited or included into the inlet 404 in any of the ways described above. It will also be appreciated that although shown as a tunnel with a uniform diameter, the inlet 404 can have a varying diameter as discussed with respect to the other examples herein.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic apparatus comprising:
a base;
a transducer coupled to the base;
an acoustic interface assembly comprising an inlet that extends from a first surface of the acoustic interface assembly to a second surface of the acoustic interface assembly, the inlet at least partially filled with a porous material; and
a cover disposed on the base and enclosing the acoustic interface assembly and the transducer, the cover including a port extending through the cover;
wherein the acoustic interface assembly is disposed proximal to the transducer and the cover such that the inlet communicates with the transducer and the port extending through the cover.

2. The acoustic apparatus of claim 1, wherein the inlet has a constant diameter along a length of the inlet.

3. The acoustic apparatus of claim 1, wherein the inlet has a varying diameter along a length of the inlet.

4. The acoustic apparatus of claim 1, wherein the porous material fills substantially all of the inlet.

5. The acoustic apparatus of claim 1, wherein the inlet includes a cavity substantially devoid of porous material.

6. The acoustic apparatus of claim 1, wherein the inlet includes a first porous material region, a second porous material region, and a cavity substantially devoid of porous material positioned between the first and second porous material regions.

7. The acoustic apparatus of claim 1, wherein the porous material is integrally formed with the acoustic interface assembly.

8. The acoustic apparatus of claim 1, wherein the inlet comprises inlet walls extending generally perpendicular to at least one of the first and second surfaces of the acoustic interface assembly.

9. The acoustic apparatus of claim 1, wherein the inlet comprises a first region including inlet walls extending generally perpendicular to at least one of the first and second surfaces of the acoustic interface assembly, and a second region including inlet walls extending generally parallel to at least one of the first and second surfaces of the acoustic interface assembly.

10. The acoustic apparatus of claim 1, wherein the inlet comprises inlet walls extending at a predefined angle with respect to at least one of the first and second surfaces of the acoustic interface assembly.

11. The acoustic apparatus of claim 1, wherein the porous material is open cell foam.

12. The acoustic apparatus of claim 1, wherein the acoustic interface assembly is constructed of rubber.
